(19) United States
(12) Patent Application Publication
(10) Pub. No.: US 2026/0140759 A1
(43) Pub. Date: May 21, 2026

(54) SYSTEMS AND METHODS FOR RESTARTING PROCESSES WITHIN WORKFLOWS

(71) Applicant: ServiceNow, Inc., Santa Clara, CA (US)

(72) Inventors: Min Wu, Pleasanton, CA (US); Yaron Guez, San Diego, CA (US); Jason Allen Lefever, Hopedale, MA (US); Oleg Timofeyevich Todorenko, San Marcos, CA (US); Amanda Stephens, Imperial Beach, CA (US)

(21) Appl. No.: 18/949,559

(22) Filed: Nov. 15, 2024

(51) Int. Cl. G06F 9/48

(52) U.S. Cl. CPC G06F 9/485

(57) ABSTRACT

A method including receiving a request to restart a workflow, wherein the workflow includes a plurality of activities, identifying a state of each activity of the plurality of activities of the workflow, determining a restart condition for each activity of the plurality of activities based on the state of each activity, and executing restart of the workflow based on the determined restart condition for each activity of the plurality of activities.

### TECHNICAL FIELD

The present disclosure relates generally to a workflow restart system. Specifically, the present disclosure relates to incorporating restart of workflows of various software products across a platform of an enterprise.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Activities and activity stages may be incorporated into workflows to efficiently automate manual processes and digital functions within cloud computing approaches. Activities represent a step in a workflow and activity stages represent a group of one or more activities in sequence within the workflow. Within the context of creation, generation, and implementation of workflows, activities and activity stages may be performed concurrently or sequentially to collect and maintain activity records that correspond to operations of an enterprise (e.g., launching services, approval processes, employee onboarding, billing, invoicing, and the like) in order to make the operations more streamlined and efficient. Previously available workflows may execute activities and activities stages with limited ability to restart processes after initialization of the workflow due to dependencies of activities and activity sequences in generating activity records. Manually restarting stopped workflows is an inefficient use of computing resources and organization user time. Accordingly, new techniques for addressing stopped workflows are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A workflow restart system is disclosed herein that enables restart functionality for activities and activity stages within workflows or applications within a platform of an enterprise. The workflow restart system may offer increased granular control of the workflow by enabling workflow restart from one or more points within the workflow. In this manner, the workflow restart system may improve efficiency of computing resources and organization user time. Further, the workflow restart system may be integrated within a graphical user interface (GUI) of the platform of the enterprise to provide insight to restart progress of the workflow restart system.

In certain aspects, the present disclosure is generally directed to a method including receiving a request to restart a workflow, wherein the workflow includes a plurality of activities, identifying a state of each activity of the plurality of activities of the workflow, determining a restart condition for each activity of the plurality of activities based on the state of each activity, and executing restart of the workflow based on the determined restart condition for each activity of the plurality of activities.

The present disclosure is directed to a system including processing circuitry and memory, accessible by the processing circuitry, the memory storing instructions that, when executed by the processing circuitry, cause the processing circuitry to perform operations. The operations include receiving a request to restart a workflow, wherein the workflow includes a plurality of activities and identifying a state of each activity of the plurality of activities of the workflow. The operations also include determining a restart condition for each activity of the plurality of activities based on the state of each activity and executing restart of the workflow based on the determined restart condition for each activity of the plurality of activities.

The present disclosure is directed to a non-transitory computer-readable storage medium including processor-executable routines that, when executed by a processor, cause the processor to perform operations. The operations include receiving a request to restart a workflow, wherein the workflow includes a plurality of activities and identifying a state of each activity of the plurality of activities of the workflow. The operations also include determining a restart condition for each activity of the plurality of activities based on the state of each activity and executing restart of the workflow based on the determined restart condition for each activity of the plurality of activities.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating an embodiment in which a virtual server, which supports and enables the client instance, hosts a workflow restart system, in accordance with aspects of the present techniques;

FIG. 5 is a schematic illustrating a framework of the workflow restart system of FIG. 4 to be utilized within an enterprise, in accordance with aspects of the present techniques;

FIG. 6 is a flow diagram of a workflow restarted by the workflow restart system of FIG. 4, in accordance with aspects of the present techniques;

FIG. 7 is a schematic embodiment of a graphical user interface (GUI) for the workflow restart system of FIGS. 4-6, in accordance with aspects of the present techniques; and

FIG. 8 is a flow chart of a process of restarting a workflow via the workflow restart system, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

In modern communication networks, examples of cloud computing services include software as a service (SaaS) and platform as a service (PaaS) technologies. SaaS is a delivery model that provides software as a service rather than an end product. Instead of utilizing a local network or individual software installations, software is typically licensed on a subscription basis, hosted on a remote machine, and accessed by client devices as needed. For example, client devices are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for developing, testing, modifying, and/or customizing applications and/or automating enterprise operations without maintaining network infrastructure and/or allocating computing resources normally associated with these functions. These cloud computing services may provide applications and/or websites for user engagement. With ever increasing implementation of new software products provided in cloud computing environments, accurate and reliable workflow management that is computationally efficient is needed.

Accordingly, the presently disclosed techniques may be used to improve techniques for managing workflows and workflow restarts within software products of an enterprise. A workflow restart system is disclosed herein that provides restart functionality for activities and activity stages (e.g., lanes) of a workflow of an enterprise. The workflow restart system enables modifications of workflows used across a platform of an enterprise. In this manner, the workflow restart system may provide workflow restart from one or more points within the workflow to offer increased granular control of the workflow. Upon restart, the workflow restart system may generate new activity context for each activity and activity sequence restarted from the one or more points within the workflow. For example, the workflow of the enterprise may be configured to collect data related to execution of a contract. Execution of the contract may require approval at various steps during execution. The workflow of the enterprise may be designed to automate data collection during the various steps of execution. The contract may be denied at a particular step in the workflow. The workflow restart system, may trigger restart of the workflow from a step prior to the particular step in which the contract was denied. In this way, activity data input at steps prior to a particular step within the workflow will be saved and the contract execution may be continued from the particular point. The workflow restart system provides modification of the workflow from the particular point without necessitating creation of a new workflow. By providing restart functionality, the workflow restart system improves efficiency of computing resources and organization user time. Additionally, present embodiments include a graphical user interface (GUI) designed to provide insight to the workflow restart system and to provide granular control to restart activities and/or activity stages of the workflow in a concise and organized format.

In some embodiments, the workflow may include one or more lanes that may be executed simultaneously or concurrently to complete a function of the workflow. The lanes may include various activities, activity sequences (e.g., paths, branches), or a combination thereof. The workflow restart system may be used to restart a particular lane of the workflow, activities within the lane, and the like. The workflow restart system may determine conditionality of restart of the lanes, the activities, and the activity sequences to ensure that the workflow upon restart may be executed from a restart point to an end point of the workflow. The workflow restart system may determine conditionality by identifying a state of each activity, activity sequence, and lane. The state may be identified as a pending state, an execution state, an error state, or a completed state. In certain embodiments, based on the state of the activity, activity sequence, or the lane the workflow restart system may execute a restart of the workflow.

In certain embodiments, the GUI of the workflow restart system may provide customization of restart functionality of the workflow. For example, one or more restart conditions may be applied to each of the activity, activity sequence, or the lane. The restart conditions may indicate that a particular activity may be skipped (e.g., bypassed) on restart, always run on restart, only run on restart, and the like. In some embodiments, a particular activity may be assigned the restart condition to only start on restart. The particular activity may include a procedure to access data stored from a previous execution of the workflow. As such, the workflow restart system may execute restart of the workflow and access data from a previous point in the workflow prior to restart. Using data stored from the previous point may reduce redundant data creation, storage, and the like streamlining workflow execution.

Use of the disclosed techniques enables workflow restart functionality with improved granular control of restart capabilities on activity, lane, or workflow levels. Accordingly, using the disclosed techniques, restarting workflows upon receiving restart requests at various points within workflows may streamline processes implemented by workflows of an enterprise by enabling restart of processes after initialization of workflows. As a result, use of the workflow restart system may reduce computational costs associated with execution of workflows during development, deployment, and/or maintenance of various workflows integrated within software products by reducing creation of entirely new workflows.

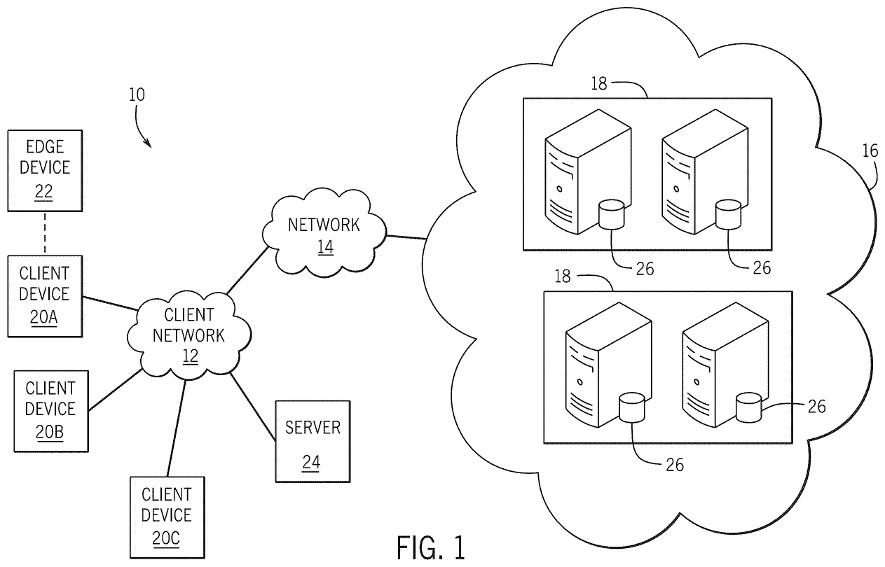

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

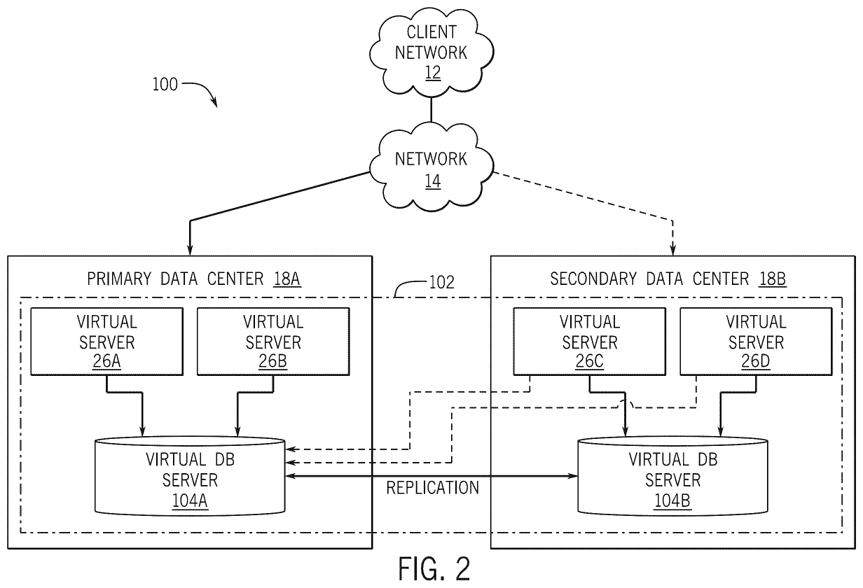

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

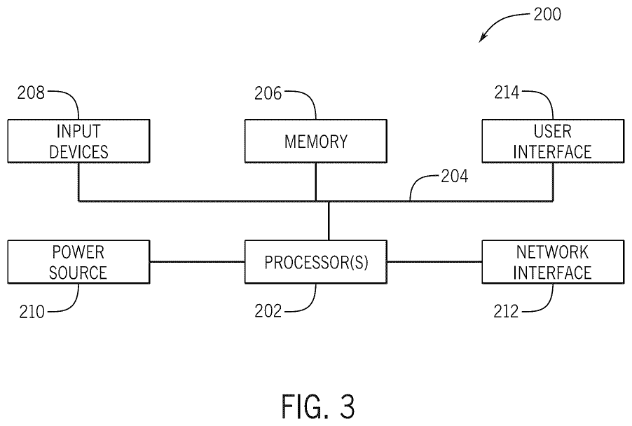

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

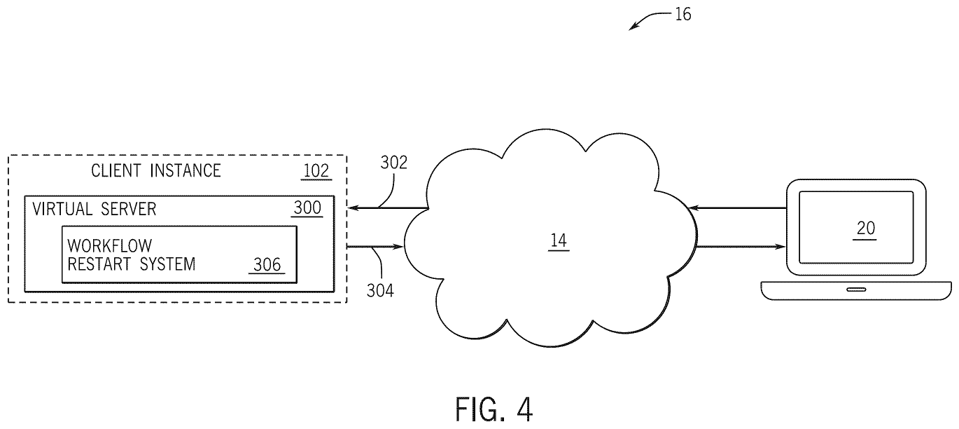

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 300 similar or identical to the virtual servers 26 explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 302, to which the client instance 102 may respond with outputs 304. In the embodiment shown in FIG. 4, the virtual servers 300 of the client instance 120 may run a workflow restart system 306, which may be a software application defined by code, accessible via a native application or web browser of the client device 20. Accordingly, the inputs 302 may include inputs requesting initiation of a workflow, pausing of a workflow, workflow restart, and so forth. In some embodiments, the workflow restart system 306 may be hosted by the client instance 102. The workflow restart system 306 may be used to restart processes of various software products, such as process automation workflows, and the like. The client instance 102 hosting the workflow restart system 306 may be accessible via the client device 20. In some embodiments, restart of workflows of the enterprise may be advantageous. For example, a workflow may be paused and/or stopped due to changes in the inputs 302 of the workflow. For example, changes in the inputs 302 may be based on changes in contracts, training materials, approval criteria, and the like. As such, it may be advantageous to incorporate restart functionality of workflows to enable various iterations of a subset of activities within workflows to be repeated, changed, updated, and the like. In this manner, various iterations of the subset of activities may be executed via the workflow restart system 306 without creation of new workflows. As such, the workflow restart system 306 may facilitate streamlined implementation of workflows of the enterprise. In this manner, the workflow restart system 306 may restart workflows associated with platforms and/or applications of the enterprise within the cloud provide infrastructures of the enterprise.

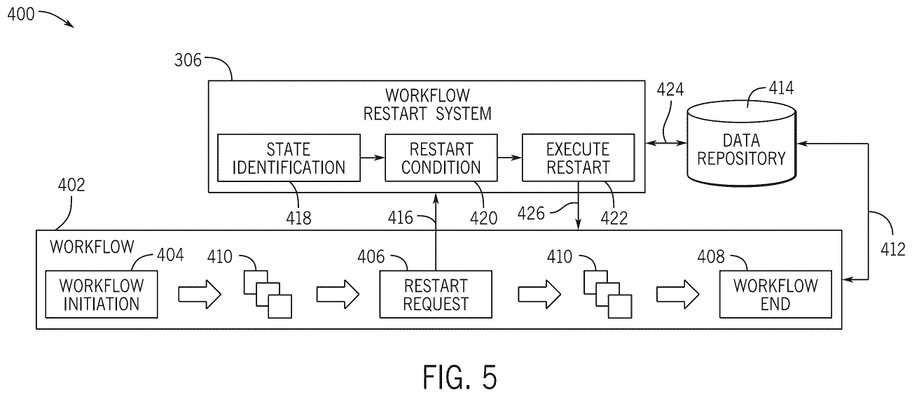

With this in mind, FIG. 5 is a framework 400 of a workflow restart system 306 to be utilized within an enterprise. The workflow restart system 306 may be used to modify a workflow 402 of an enterprise. The workflow restart system 306 and the workflow 402 may be executed from the platform 16 of the enterprise. It should be noted, the framework 400 of FIG. 5 is one non-limiting example of the workflow restart system 306 and the workflow 402 and that the illustrated stages are provided as examples and more, fewer, or different stages may be included in the framework 400 of the workflow restart system 306 and workflow 402. Further, the workflow restart system 306 and workflow 402 of the framework 400 may be executed by the client device 20, or any other suitable device(s) or controller(s).

In some embodiments, the workflow 402 may be used for automation of manual processes and digital functions of the enterprise. The workflow 402 may include a workflow initiation stage 404, a restart request stage 406, and a workflow completion stage 408. The illustrated stages of the workflow 402 are provided as examples and more, fewer, or different stages may be included in the workflow 402. The workflow initiation stage 404 may initiate execution of a plurality of activities 410. The activities 410 may represent one or more steps in the workflow 402. A subset of the activities 410 may represent activity stages (e.g., lanes). The lanes may include a group of one or more activities within the workflow 402. The workflow 402 may execute the activities 410 within lanes in a particular sequence. For example, the activities 410 within a particular lane may be organized within one or more paths. The paths may be performed concurrently or sequentially during execution of the activities 410 within the particular lane. For example, execution of a particular activity of the activities 410 may be based on completion of one or more preceding activities or one or more preceding paths. As such, the workflow initiation stage 404 may direct execution of a subset of the activities 410 based on the state of each activity and associated dependencies of each activity on the preceding activities, lanes, or paths.

In some embodiments, the state of each activity may include a pending state, an in-progress state, a completed state, a cancelled state, or an error state. Transition between each state of the activities 410 may be based on one or more dependencies of the preceding activities. The workflow initiation stage 404 may initially trigger a first subset of the activities 410. Upon initiation, the first subset of the activities 410 may transition from the pending state to the in-progress state. For example, dependencies of the activities 410 may specify an order of execution the activities 410 within the workflow 402. The order of execution may dictate an activity B depends on an activity A. As such, activity B may begin execution (e.g., transition from the pending state to the in-progress state) when activity A is in the completed state. Additionally and/or alternatively, a subset of activities may run in parallel while an additional activity X depends on the completion of the subset of activities. In this way, activity X may be executed after each of the activities 410 in the subset of activities reaches the completed state.

In some embodiments, the workflow 402 may continue to proceed through each of the activities 410 or subset of activities until each activity reaches the completed state or the failed state. Execution of the activities 410 may generate one or more activity contexts. The activity contexts may be associated with each of the activities 410. The activity contexts may include the state (e.g., an execution state), input data, run-time data, or a combination thereof. The activity contexts of each activity of the activities 410 executed by the workflow 402 may be used to collect and maintain one or more activity records 412 that may be stored in a data repository 414. The activity records 412 may correspond to operations of an enterprise (e.g., launching services, approval processes, employee onboarding, billing, invoicing, and the like) and may be stored in the data repository 414 to streamline operations of the enterprise. In some embodiments, the activity records 412 of one or more of the activities 410 may be retrieved upon execution of a restart of the workflow 402.

In some embodiments, the workflow 402 may progress to the workflow completion stage 408 upon completion and/or failure of each of the activities 410. The workflow completion stage 408 may direct the activity contexts for each of the activities 410 into the data repository 414. The workflow completion stage 408 may generate one or more workflow reports based on completion of the workflow 402. The workflow reports may include the activity records 412 of a subset of the plurality of activities 410 of the workflow 402. Additionally and/or alternatively, the workflow 402 may proceed to the workflow initiation stage 404. The workflow initiation stage 404 may be executed from one or more restart points (e.g., one or more points) within the workflow 402. It should be noted, that the one or more restart points within the workflow 402 may include one or more particular activities, one or more lanes, one or more paths, and the like. The restart points may be based on a restart condition and/or a lane setting input during design of the workflow 402.

In some embodiments, the restart request stage 406 may send a restart request 416 to the workflow restart system 306 at a particular restart points during execution of the workflow 402. The restart request 416 may initiate the workflow restart system 306. The workflow restart system 306 may be used to determine the states of each of the activities 410 of the workflow 402, configure the activities 410 for restart, and execute restart of the workflow 402 at the one or more restart points. The workflow restart system 306 may include various stages such as a state identification stage 418, a configuration stage 420, and a restart execution stage 422. The illustrated stages of the workflow restart system 306 are provided as examples and more, fewer, or different stages may be included in the workflow 402.

In certain embodiments, the workflow restart system 306 may receive the restart request 416 from the workflow 402 to initiate the state identification stage 418. The state identification stage 418 may determine the state of each of the activities 410 of the workflow 402. The states may include the pending state, the completed state, the cancelled state, or the error state. Each state of the activities 410 may be based on the state of the activities at the restart point. For example, if the activity A is in the in-progress stage prior to the restart point, the state identification stage 418 may determine that the activity A is in the cancelled state after termination of the workflow 402. Based on a dependency of activity B on activity A, activity B may be in the pending state prior to the restart point. As such, the state identification stage 418 may determine that the activity B may be in the pending state.

In some embodiments, after determination of each state of the activities 410 of the workflow 402 the workflow restart system 306 may proceed to the configuration stage 420. The configuration stage 420 may determine a restart condition and/or a restart context for each of the activities 410 of the workflow 402. The restart conditions may include “skip on restart”, “run on restart”, “only run on restart”, and the like. A particular restart condition may be assigned to each activity of the activities 410 of the workflow 402. In some embodiments, the restart condition may be assigned on a lane level. As such, a particular lane may be designated to “only run on restart.”

In certain embodiments, the configuration stage 420 may generate a restart context for each of the activities 410 within the workflow 402 based on the determined states and/or the restart conditions. The restart context may include the state, input data, run-time data, or a combination thereof. The workflow restart system 306 may determine the restart context for each of the activities 410 based on the one or more activity records 412 stored in the data repository 414. As such, the workflow restart system 306 may access data stored in the data repository 414. Continuing with the example of activity A above, the restart condition of “always run on restart” may direct the configuration stage 420 to generate an associated restart context for activity A. The associated restart context for activity A may include the state and one or more input data fields or run-time data fields that may be generated upon restart. It should be noted, that in some embodiments, a particular activity may include one or more activity contexts and/or one or more restart contexts. In this way, upon completion of the workflow 402 a last executed context may be saved in the activity record 412 within the data repository 414.

In some embodiments, the workflow restart system 306 may proceed to the restart execution stage 422. The restart execution stage 422 may provide an input 426 to the workflow 402 to execute restart of the workflow 402. Restart of the workflow may proceed from the restart point, or one or more additional points within the workflow. For example, the restart execution stage 422 may execute restart of the workflow from the restart point (e.g., a particular activity, a particular lane). In some embodiments, the restart execution stage 422 may determine that the workflow 402 may only be restarted from a particular point within the workflow 402 based on the determined states, restart conditions, restart context, or a combination thereof of the activities 410 of the workflow 402. As such, execution of the restart execution stage 422 may be used to facilitate restart of the workflow 402. As such, restart of the workflow 402 may execute a subset of the activities 410 of the workflow 402 or all activities 410 of the workflow 402. In some embodiments, the workflow restart system 306 may populate the restart contexts with input data and/or restart data stored in the activity records 412 of the data repository 414 during one or more previous runs of the workflow 402. In certain embodiments, the workflow restart system 306 may access one or more restart activity records 424 that may be stored in the data repository 414 to resume data collection, generation, and the like of the workflow 402. The one or more restart activity records 424 may include data from one or more of the activity records 412 or one or more additional data sources.

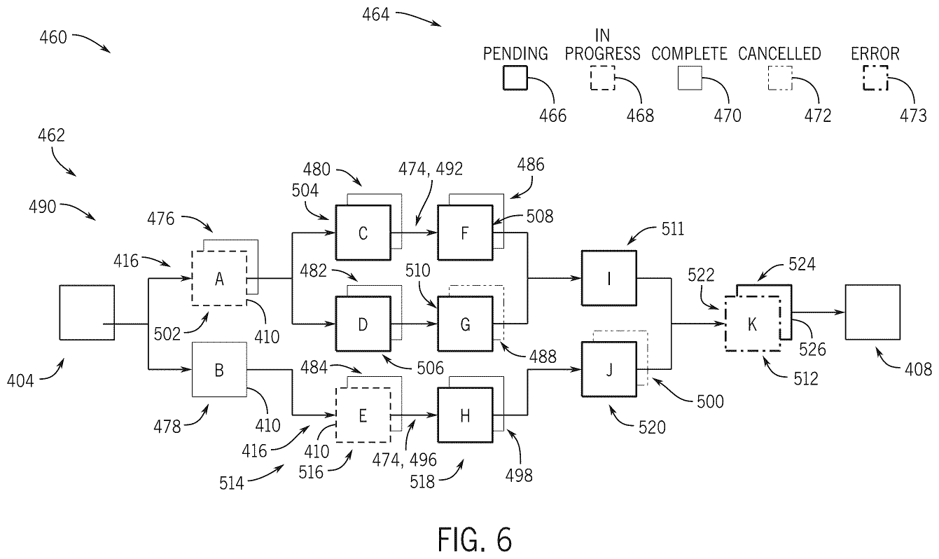

FIG. 6 is a schematic embodiment of a flow diagram 460 of the workflow restart system 306 of FIG. 4. The flow diagram 460 may include a workflow 462. The workflow 462 may include a workflow initiation stage 404 and a workflow completion stage 408. The workflow 462 may include one or more activities 410. Upon execution of the workflow 462, the activities 410 may be in one or more states 464. The states 464 may include a pending state 466, an in-progress state 468, a completed state 470, a cancelled state 472, an error state 473, or one or more additional state. In certain embodiments, the activities 410 may be organized in one or more paths 474 (e.g., branches). The paths 474 may include one or more dependencies based on completion of particular activities. In some embodiments, one or more of the paths 474 may be executed in parallel.

The workflow initiation stage 404 may prompt execution of the workflow 462. As such, an activity A 476 and an activity B 478 may be initiated. Initiation of the activity A 476 and the activity B 478 may transition each respective activity from the pending state 466 to the in-progress state 468. In some embodiments, the activity A 476 may transition from the in-progress state 468 to the completed state 470 after execution of the activity A. Transition of the activity A 476 to the completed state 470 may prompt execution of an activity C 480 and an activity D 482. As such, the activity C 480 and the activity D 482 may be executed and may transition from the pending state 466 to the in-progress state 468. In some embodiments, the activity B 478, activity C 480, and the activity D 482 may simultaneously be in the in-progress state 468 for a portion of time. In certain embodiments, the activity B 478 may transition from the in-progress state 468 to the completed state 470 upon completion of the activity B 478. Completion of the activity B 478 may prompt the transition of an activity E 484 from the pending state 466 to the in-progress state 468.

In some embodiments, the activity C 480 may transition from the in-progress state 468 to the completed state 470. Completion of the activity C 480 may prompt the transition of an activity F 486 from the pending state 466 to the in-progress state 468. The activity F 486 may transition from the in-progress state 468 to the completed state 470. In some embodiments, the activity D 482 may transition from the in-progress state 468 to the completed state 470. Completion of the activity D 482 may prompt the transition of an activity G 488 from the pending state 466 to the in-progress state 468.

In certain embodiments, the workflow 462 may continue execution of the activities 410. For example, each of the activities 410 of the paths 474 may transition to the completed state 470. As such, the workflow 462 may progress to the workflow completion stage 408. Additionally and/or alternatively, the workflow 462 may be paused and/or stopped upon receiving at the restart request stage 406. The workflow 462 may be stopped at a particular activity based on lack of approval of data within the activity record 412 for the particular activity. For example, the workflow 462 may be stopped based on not meeting an approval threshold, a data field threshold (e.g., data marked as missing), a rating threshold (e.g., score, business goal), and the like. As such, the workflow 462 may be restarted at the restart request stage 406.

In some embodiments, a restart request 416 may be received by the workflow restart system 306 to restart a portion of the workflow 462. The restart request 416 may be received at a point 490 corresponding to the activity A 476 of the workflow 462. As such, the restart portion of the workflow 462 may be stopped (e.g., terminated) by the workflow restart system 306. The restart portion of the activities 410 may be positioned subsequent to the activity A 476. In this way, the workflow restart system 306 may terminate the activity A 476, a first path 492, and a second path 494 of the workflow 462. The first path 492 may include the activity C 480 and the activity F 486. The second path 494 may include the activity D 482 and the activity G 488. It should be noted, that a third path 496 may continue execution during restart from the point 490. The third path 496 may include the activity E 484, an activity H 498, and an activity J 500. As such, the activity E 484 may remain in the in-progress state 468 during restart of the restart portion of the activities 410.

In some embodiments, the workflow restart system 306 may terminate the portion of the workflow 462 subsequent to the point 490. As such, the activity A 476, the activity C 480, the activity D 482, and the activity F 486 may be terminated in the completed state 470 and the activity G 488 may be terminated in the in-progress state 468. Termination of the activity G 488 may transition the activity G 488 from the in-progress state 468 to the cancelled state 472.

In certain embodiments, the state identification stage 418 of the workflow restart system 306 may determine the state 464 of each of the activities 410 within the stopped workflow (e.g., the restart portion of the workflow 462). The activity A 476, the activity C 480, the activity D 482, and the activity F 486 may be in the completed state 470 and the activity G 488 may be in the cancelled state 472. The workflow restart system 306 may proceed to the configuration stage 420 to determine a restart condition and/or a restart context for each of the activities 410 of the restart portion of the workflow 462. The restart condition of the activity A 476 may include be determined to be “always run on restart.” As such, the workflow restart system 306 may generate a restart context for the activity A 476. The restart context for the activity A 476 may include generating an updated activity A 502 such that the updated activity A 502 may transition from the pending state 466 to the in-progress state 468 upon restart of the portion of the workflow 462.

In some embodiments, the workflow restart system 306 may proceed to determine a restart condition for the activities 410 within the first path 492 and the second path 494. The restart condition of the activities 410 within the first path 492 and the second path 494 may be determined to be “always run on restart.” As such, the workflow restart system 306 may generate restart contexts for each activity within the first path 492 and the second path 494. The restart contexts for each activity within the first path 492 and the second path 494 may include generating updated activities such that the updated activities may begin in the pending state 466 upon restart of the portion of the workflow 462 based on the activities'dependencies on completion of the activity A 476. As such, an updated activity C 504, an updated activity D 506, an updated activity F 508, and an updated activity G 510 may be generated in the pending state 466.

In certain embodiments, the workflow restart system 306 may proceed to the restart execution stage 422 and provide an input to the workflow 462 to execute restart of the restart portion of the workflow 462. As such, the updated activity A 502 may be in the in-progress state 468 and the updated activity C 504, the updated activity D 506, the updated activity F 508, and the updated activity G 510 may be in the pending state 466. It should be noted, in some embodiments, the workflow 462 may proceed to execute the activities 410 in the first path 492 and the second path 494 upon completion of the updated activity A 402. Completion of the first path 492 and the second path 494 may trigger execution of an activity I 511. Additionally and/or alternatively, completion of the activity I 511 and the third path 496 may trigger execution of an activity K 512. Completion of the activity K 512 may end the workflow 462.

In some embodiments, the workflow restart system 306 may receive an additional restart request at one or more points prior to and/or subsequent to completion of the workflow 462. For example, the workflow restart system 306 may receive a restart request 416 at an additional point 514. The additional point 514 may correspond to the activity E 484. The workflow restart system 306 may terminate the third path 496. In some embodiments, termination of the third path 496 may terminate the activities 410 positioned downstream (e.g., subsequent) to the activity E 484. As such, the state identification stage 418 of the workflow restart system 306 may determine the state 464 of each of the activities 410 within the third path 496 of the workflow 462. The activity E 484, and the activity H 498 may be in the completed state 470 and the activity J 500 may be in the cancelled state 472.

The workflow restart system 306 may proceed to the configuration stage 420 to determine a restart condition and/or a restart context for each of the activities 410 of the third path 496 of the workflow 462. The restart condition of the activity E 484 may be determined to be “always run on restart.” As such, the workflow restart system 306 may generate a restart context for the activity E 484. The restart context for the activity E 484 may include generating an updated activity E 516 such that the updated activity E 516 may transition from the pending state 466 to the in-progress state 468 upon restart of the third path 496 of the workflow 462.

In some embodiments, the workflow restart system 306 may proceed to determine a restart condition for the activity H 498 and the activity J 500. The restart condition of the activity H 498 and the activity J 500 may be determined to be “always run on restart.” As such, the workflow restart system 306 may generate restart contexts for the activity H 498 and the activity J 500. The restart contexts for the activity H 498 and the activity J 500 include generating an updated activity H 518 and the updated activity J 520 such that the updated activities may begin in the pending state 466 upon restart of the third path 496 of the workflow 462.

In certain embodiments, the workflow restart system 306 may proceed to the restart execution stage 422 and provide an input to the workflow 462 to execute restart of the third path 496 of the workflow 462. As such, the updated activity E 516 may be in the in-progress state 468 and the updated activity H 518 and the updated activity J 520 may be in the pending state 466. It should be noted, in some embodiments, the workflow 462 may proceed to execute the activities 410 in the updated activity H 518 and the updated activity J 520 upon completion of the updated activity E 516. Completion of the activity I 511 and the third path 496 may trigger execution of the activity K 512. In some embodiments, the activity K 512 may end in the error state 473. As such, the workflow 462 may receive a restart request 522 at a point 524. The point 524 may correspond to the activity K 512. The workflow restart system 306 may proceed to the configuration stage 420 to determine a restart condition and/or a restart context for each of the activities 410 of the workflow 462. The restart condition of the activity K 512 may be determined to be “always run on restart.” As such, the workflow restart system 306 may generate a restart context for the activity K 512. The restart context for the activity K 512 may include generating an updated activity K 526 such that the updated activity K 526 may transition from the error state 473 to the in-progress state 468 upon restart of the workflow 462 from the point 524. Completion of the activity K 512 or the updated activity K 526 may end the workflow 462. It should be noted, that one or more additional restart requests may be received by the workflow 462. FIG. 6 is one non-limiting example and embodiments are envisaged in which various other workflows are restarted.

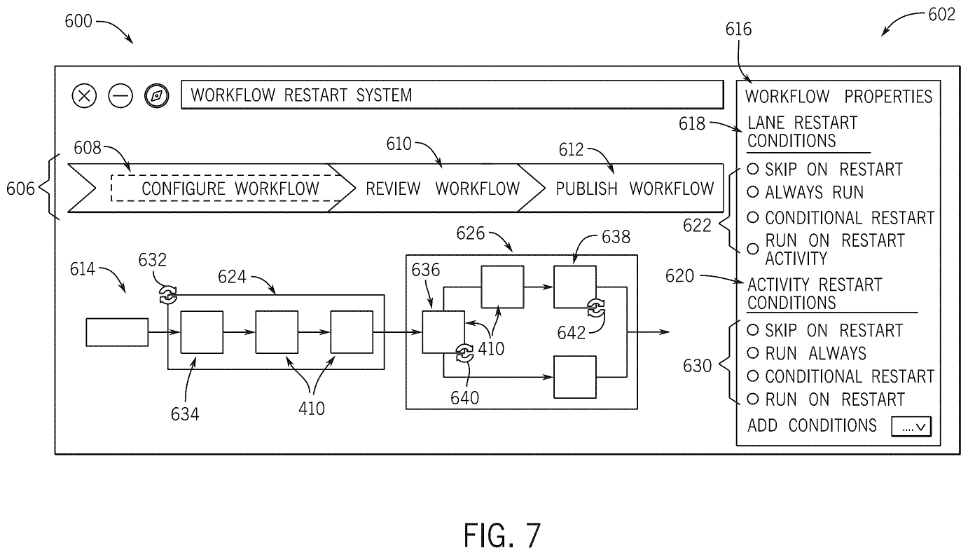

FIG. 7 is a schematic embodiment of a graphical user interface (GUI) 600 for the workflow restart system 306 of FIGS. 4-6 depicted as displayed on a screen 602. The workflow restart system 306 may provide (e.g., generate and/or cause the display of) the GUI 600 to the client device 20 via a display. The GUI 600 may allow the user to select, view, and/or manage one or more applications 606 deployed by the workflow restart system 306. The applications 606 may include a configuration window 608, a review window 610, a publish window 612, and/or one or more additional windows. As shown, the configuration window 608 is selected to display on the screen 602 of the GUI 600. The applications 606 represent applications that may be edited and/or modified by the user.

In some embodiments, the GUI 600 may display the configuration window 608 to provide information related to configuring a workflow 614 for restart. In certain embodiments, the GUI 600 may allow the client device 20 to select one or more workflow properties 616 to analyze and/or manage restart of the workflow 614. The workflow properties 616 may include lane restart conditions 618, activity restart conditions 620, and one or more additions property inputs used by the workflow restart system 306. In some embodiments, the lane restart conditions 618 may include one or more lane input fields 622. The lane input fields 622 may be used to designate restart conditions for lanes of the workflow 614. For example, the workflow 614 may include a first lane 624, a second lane 626 and one or more additional lanes. As such, the lane restart conditions 618 may be used to input restart conditions for the first lane 624, the second lane 626 or a combination thereof. In some embodiments, lanes of the workflow 614 may include one or more activities 410. The activity restart conditions 620 may include one or more activity restart condition inputs 630. The activity restart condition inputs 630 may be used to select restart conditions of one or more activities 410 within the first lane 624, the second lane 626, or one or more additional lanes. In certain embodiments, the first lane 624 and the second lane 626 may include a subset of the one or more activities 410.

The activity restart condition inputs 630 may be used to designate restart conditions on an activity level and the lane restart conditions 618 may be used to designate restart conditions on a lane level. As such, restart conditions of the workflow 614 may be controlled on a granular level to increase restart functionality of the workflow restart system 306. For example, the workflow restart system 306 may be used to configure restart conditions of the lanes 624, 626 the activities 410, or a combination thereof. For example, a restart condition 632 may be selected for the first lane 624. The restart condition 632 may be selected from the lane input fields 622. In some embodiments, the restart condition 632 for the first lane 624 may be set as “restart from first activity.” As such, upon restart the first lane 624 may restart from a first activity 634 of the first lane 624. In some embodiments, the restart condition 632 for the second lane 626 may be selected from the lane input fields 622. The restart condition 632 for the second lane 626 may be set as “conditional restart.” As such, the second lane 626 may be customized to restart based on one or more rules. For example, the second lane 626 may be customized to restart based on a particular restart condition of one or more activities executed previously or subsequently to execution of the second lane 626.

In some embodiments, the workflow restart system 306 may be used to configure restart conditions for specific activities. For example, a second activity 636 and a third activity 638 may be configured to have a second restart condition 640 and a third restart condition 642, respectively. The second and third restart condition 640, 642 may be selected from the activity restart conditions inputs 630. The second restart condition 640 may be selected to correspond to “run always.” In this way, the second activity 636 may run on initial execution and upon one or more restarts. In some embodiments, the second activity 636 may be selected to correspond to “skip on restart.” In this way, the second activity 636 may be omitted from the workflow 614 upon restart. It should be noted, that the second activity 636 may only be skipped on restart when the second activity 636 has reached the completed state 470 on a prior execution of the workflow 614. That is, “skip on restart” may be applied subsequent to completion of the second activity 636.

In certain embodiments, the third restart condition 642 may be selected to correspond to “run on restart.” As such, the third activity 638 may only run upon restart of the workflow 614 or a portion of the workflow 614. In some embodiments, the third activity 638 may be include instructions to access data in the data repository 414 to load data from one or more previous executions of the workflow 614. It should be noted, that one or more additional lanes and/or one or more additional activities may be configured to restart using the workflow properties 616 (e.g., the lane restart conditions 618, the activity restart conditions 620, or a combination thereof). In some embodiments, the third activity 638 may be selected to correspond to “conditional restart.” As such, the third activity 638 may be customized to restart based on one or more rules. For example, the third activity 638 may be restarted without impacting other activities within the workflow 614. In this manner, the third activity 638 may be restarted to gather additional data, update a particular field within the workflow 614, and the like. Increasing granular control via conditional restart inputs may increase functionality of the workflow restart system 306 and reduce computational inefficiencies.

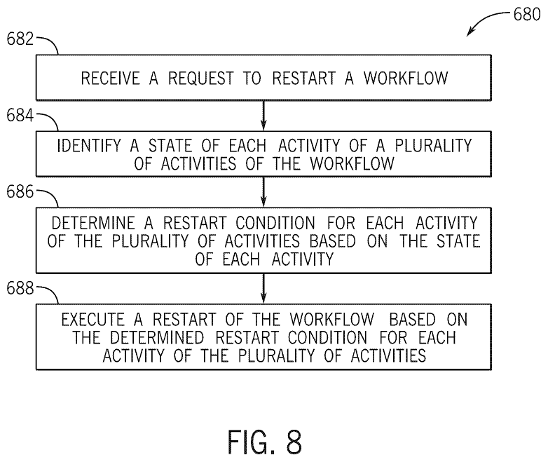

FIG. 8 is a flow chart of a process 680 of the workflow restart system 306. The process 680 may be performed by the client device 20, a computing device or controller disclosed above with reference to FIG. 1 or any other suitable computing device(s) or controller(s). Furthermore, the blocks of the process 680 may be performed in the order disclosed herein or in any suitable order. For example, certain blocks of the process may be performed concurrently. In addition, in certain embodiments, at least one of the blocks of the process 680 may be omitted.

At block 682 of the process 680, the workflow restart system 306 may receive a request to restart a workflow. The request may be received at one or more points within the workflow. In some embodiments, the request may be received at a particular activity. Additionally and/or alternatively, the request to restart the workflow may be received at a particular lane (e.g., a particular activity stage). The request may be received at a time prior to completion of the workflow or at a time after completion of the workflow. The request to restart the workflow may be received at various points enabling granular control of the workflow on various levels (e.g., activity level, lane level, workflow level), whereas previously, in an absence of generation of the request to restart an entirety of the workflow is restarted or generated as a new workflow upon termination of the workflow prior to completion.

At block 684 of the process 680, the workflow restart system 306 may identify a state of each activity of a plurality of activities of the workflow. The state may include a pending state, an in-progress state, a cancelled state, or a completed state. The state of each of the activities may be determined after termination of the workflow. For example, a first activity may be in progress state upon when the workflow restart system 306 receives the request to restart. Upon termination of the workflow, the first activity may transition from the in-progress state to the cancelled state.

At block 686 of the process 680, the workflow restart system 306 may determine a restart condition for each activity of the plurality of activities based on the state of each activity. The restart condition may indicate that a particular activity may be skipped on restart, always run on restart, only run on restart, and the like. In some embodiments, a second activity may be assigned the restart condition to only start on restart. As such, the second activity may be skipped during initial execution of the workflow.

In some embodiments, the workflow restart system 306 may generate a restart context for each activity of the plurality of activities based on the state of the activity and the restart condition of respective activities. Generation of the restart context may include generating an updated activity. The updated activity may be in a restart state. The restart state may be the same or different than the state of the activity upon termination of the workflow. For example, the activity may be terminated while in the in-progress state. As such, the activity may transition from the in-progress state to the cancelled state. The workflow restart system 306 may determine that upon restart the updated activity may be in the pending state. The restart context for the updated activity may include data fields directed to input data and/or run-time data generated during execution of the updated activity. As such, the updated activity may store updated activity records in the data repository of the workflow restart system 306. In some embodiments, one or more activity records generated on one or more prior executions of a particular activity may be used to generate the restart context of the updated activity. As such, data collected from the prior executions of the particular activity may be used to ensure continued execution of the workflow from the restart point. In this way, the workflow restart system 306 may provide modification of the workflow from the restart point without necessitating creation of a new workflow or a new activity record for an entirety of the workflow.

At block 688 of the process 680, the workflow restart system 306 may execute a restart of the workflow based on the determined restart condition for each activity of the plurality of activities. The restart of the workflow may be executed from the point in which the request for the restart is received. As such, the workflow restart system 306 may restart the workflow from a particular activity or a particular lane. In some embodiments, a first portion of the workflow may continue to execute during restart of a second portion of the workflow. It should be noted, that the workflow may be restart from one or more additional points. As such, the workflow restart system 306 may facilitate granular control of execution of the workflow without creation of a new workflow.

The present disclosure is directed to a workflow restart system 306 to streamline workflow restart for applications of an enterprise. In this manner, the workflow restart system 306 may identify one or more states of each activity of the workflow, determine one or more restart conditions in real-time or near-real-time, and execute restart of the workflow based on the determined restart conditions. The workflow restart system 306 may also generate new activity contexts for each activity and lanes restarted to collect data related to execution of the workflow. Additionally, present embodiments include creation of GUIs designed to configure restart conditions of the workflow restart system 306 and/or display restart processes within the platform of the enterprise. In this manner, the workflow restart system 306 provides streamlined access to restart control of activities, paths, and lanes (e.g., activity stages) of the workflow. Integration of the workflow restart system 306 on the platform of the enterprise allows streamlined workflow restart during development, deployment, and/or maintenance of various workflows integrated within software products. Previously, workflows executed activities, paths, and lanes (e.g., activity stages) with limited ability to restart processes after initialization. By streamlining restart functionality through incorporation of the workflow restart system 306, workflows within software products of the enterprise may be restart with increased granular control enabling restart of the workflow from various points within the workflow. The disclosed techniques result in better restart functionality for activities and lanes within platforms of the enterprise, which improves end user experiences of cloud computing services offered by the enterprise.

Technical effects of the disclosed techniques include use of the workflow restart system to provide workflow restart capabilities to various platforms hosted by software products of an enterprise. The workflow restart system may include various stages such as a state identification stage, a configuration stage, and an execution stage. The workflow restart system may result in reduced computational costs associated with less time spent manually restarting stopped workflows. Further, deployment of the presently disclosed techniques may provide improved efficiency and performance of restart functionality of a workflow of the enterprise.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a request to restart a workflow, wherein the workflow comprises a plurality of activities;
identifying a state of each activity of the plurality of activities of the workflow;
determining a restart condition for each activity of the plurality of activities based on the state of each activity; and
executing restart of the workflow based on the determined restart condition for each activity of the plurality of activities.

2. The method of claim 1, wherein the state of each activity of the plurality of activities comprises a pending state, an in-progress state, an error state, a cancelled state, or a completed state.

3. The method of claim 1, wherein the restart condition comprises a skip on restart condition, a run on restart condition, or an only run on restart condition.

4. The method of claim 3, wherein an activity of the plurality of activities having the skip on restart condition is bypassed during restart of the workflow.

5. The method of claim 3, wherein an activity of the plurality of activities having the run on restart condition is executed during restart of the workflow.

6. The method of claim 1, comprising providing a graphical user interface (GUI) configured to display the state of each activity of the plurality of activities, and wherein the GUI is configured to display the restart condition for each activity of the plurality of activities during restart of the workflow.

7. The method of claim 6, wherein the request to restart comprises an indication of a restart point within the workflow.

8. The method of claim 7, wherein the restart point corresponds to an activity of the plurality of activities.

9. The method of claim 1, comprising generating a restart context for each activity of the plurality of activities based on the state and the restart condition of each respective activity.

10. The method of claim 1, wherein the workflow is a stopped workflow.

11. A system, comprising:
processing circuitry; and
memory, accessible by the processing circuitry, the memory storing instructions that, when executed by the processing circuitry, cause the processing circuitry to perform operations comprising:
receiving a request to restart a workflow, wherein the workflow comprises a plurality of activities;
identifying a state of each activity of the plurality of activities of the workflow;
determining a restart condition for each activity of the plurality of activities based on the state of each activity; and
executing restart of the workflow based on the determined restart condition for each activity of the plurality of activities.

12. The system of claim 11, wherein the state of each activity of the plurality of activities comprises a pending state, an in-progress state, an error state, a cancelled state, or a completed state.

13. The system of claim 11, wherein the restart condition comprises a skip on restart condition, a run on restart condition, or an only run on restart condition.

14. The system of claim 13, wherein an activity of the plurality of activities having the skip on restart condition is bypassed during restart of the workflow.

15. The system of claim 11, wherein the processing circuitry performs operations comprising providing a graphical user interface (GUI) configured to display the state of each activity of the plurality of activities, and wherein the GUI is configured to display the restart condition for each activity of the plurality of activities during restart of the workflow.

16. The system of claim 15, wherein the processing circuitry performs operations comprising generating a restart context for each activity of the plurality of activities based on the state and the restart condition of each respective activity.

17. A non-transitory computer-readable storage medium, comprising processor-executable routines that, when executed by a processor, cause the processor to perform operations comprising:
receiving a request to restart a workflow, wherein the workflow comprises a plurality of activities;
identifying a state of each activity of the plurality of activities of the workflow;
determining a restart condition for each activity of the plurality of activities based on the state of each activity; and
executing restart of the workflow based on the determined restart condition for each activity of the plurality of activities.

18. The non-transitory computer-readable storage medium of claim 17, wherein the state of each activity of the plurality of activities comprises a pending state, an in-progress state, an error state, a cancelled state, or a completed state.

19. The non-transitory computer-readable storage medium of claim 17, wherein the restart condition comprises a skip on restart condition, a run on restart condition, or an only run on restart condition.

20. The non-transitory computer-readable storage medium of claim 17, wherein the processor performs operations comprising generating a restart context for each activity of the plurality of activities based on the state and the restart condition of each respective activity.
